(19) United States
(12) Patent Application Publication
(10) Pub. No.: US 2008/0284112 A1
(43) Pub. Date: Nov. 20, 2008

(54) GASKET HAVING FORMED LOAD BEARING COMPRESSION LIMITING FEATURES

(75) Inventors: Steve G. Koch, Gregory, MI (US); Thomas A. Boardman, Tilton, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/962,879

(22) Filed: Dec. 21, 2007

Related U.S. Application Data
(63) Continuation-in-part of application No. 11/750,646, filed on May 18, 2007.

(51) Int. Cl. F16J 15/02

(52) U.S. Cl. 277/590

(57) ABSTRACT

A gasket is provided with a metallic or plastic substrate formed to provide a raised bead portion that has a concave surface that is filled with over molded elastomeric material to create a load bearing compression limiting feature to control compression on the over molded gasket material.

### CROSS-REFERENCE TO RELATED APPLICATIONS

This application is a continuation-in-part of U.S. patent application Ser. No. 11/750,646 filed on May 18, 2007, the disclosure of which is incorporated herein by reference.

### FIELD

The present disclosure relates to gaskets and more particularly, to a gasket having a metal or plastic substrate with formed load bearing compression limiting features.

### BACKGROUND AND SUMMARY

The statements in this section merely provide background information related to the present disclosure and may not constitute prior art.

Current gaskets for stamped pan or cover applications, known as an over-molded gasket, consist of a thin stamped metallic carrier with inserted sintered compression limiters. The inserted sintered compression limiters add extra cost to the metallic carrier to create the necessary load bearing compression limiting feature. Further, plastic carriers are currently used but they require metal inserts to prevent over compression. The present disclosure provides a compression limiting feature, formed in the metal or plastic gasket substrate, to eliminate the necessity of an additional sintered component and an additional assembly step.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a plan view of a metallic gasket substrate according to the principles of the present disclosure;

FIG. 2 is a cross-sectional view of a gasket illustrating a raised bead portion of the metallic gasket substrate according to the present disclosure;

FIG. 3 is a cross-sectional view of a gasket illustrating a portion of the gasket intermediate to the raised bead portion of the metallic gasket substrate according to the present disclosure;

FIG. 4 is a perspective view of a gasket substrate according to the principles of the present disclosure with a continuous raised bead portion; and

FIG. 5 is a plan view of a metallic gasket substrate according to the principles of the present disclosure;

FIG. 6 is a cross-sectional view taken along line 6-6 of FIG. 5;

FIG. 7 is a cross-sectional view taken along line 7-7 of FIG. 5;

FIG. 8 is an alternative cross-sectional view taken along line 7-7 of FIG. 5;

FIG. 9 is an alternative cross-sectional view of a gasket illustrating a metallic gasket substrate varying height compression limiters and a void volume type bead;

FIG. 10 is an alternative cross-sectional view of a gasket illustrating a plastic gasket substrate;

FIG. 11 is a perspective view of a metallic gasket substrate having varying widths at or between the bolt hole locations;

FIG. 12 is a perspective view of a gasket section having rubber overmold with varying heights; and

FIG. 13 is a perspective view of a gasket substrate section illustrating variation in the formed compression limiters.

### DETAILED DESCRIPTION

The following description is merely exemplary in nature and is not intended to limit the present disclosure, application, or uses. It should be understood that throughout the drawings, corresponding reference numerals indicate like or corresponding parts and features.

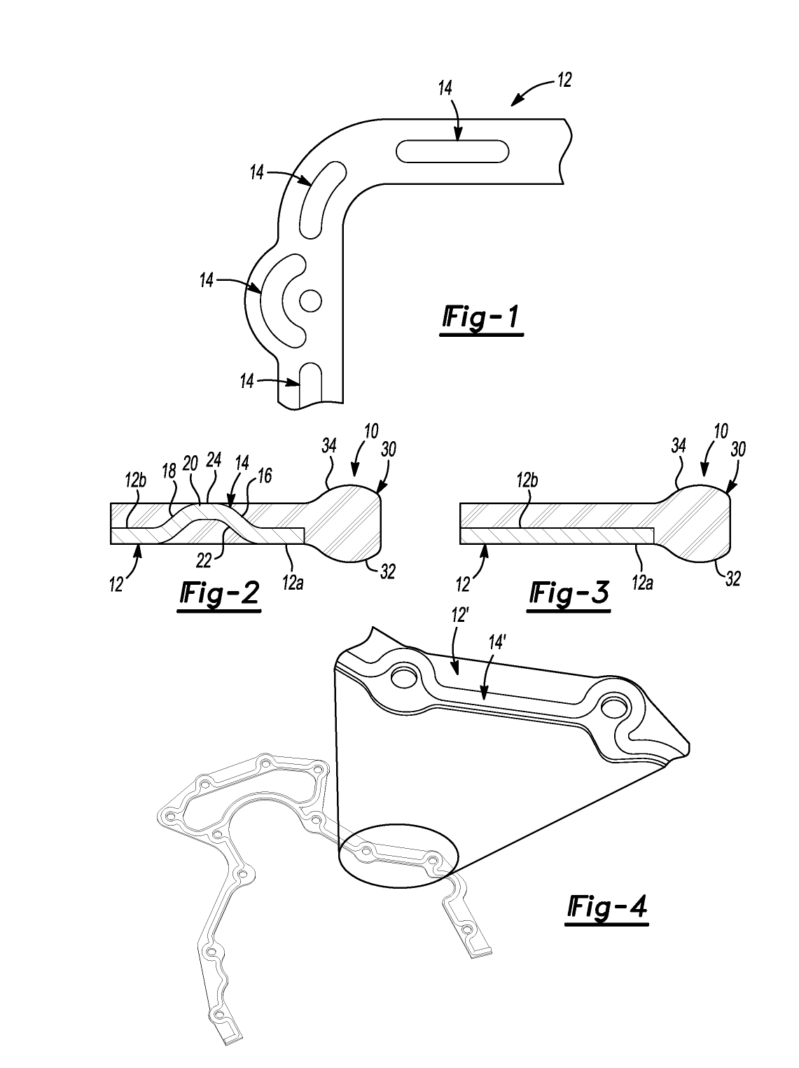

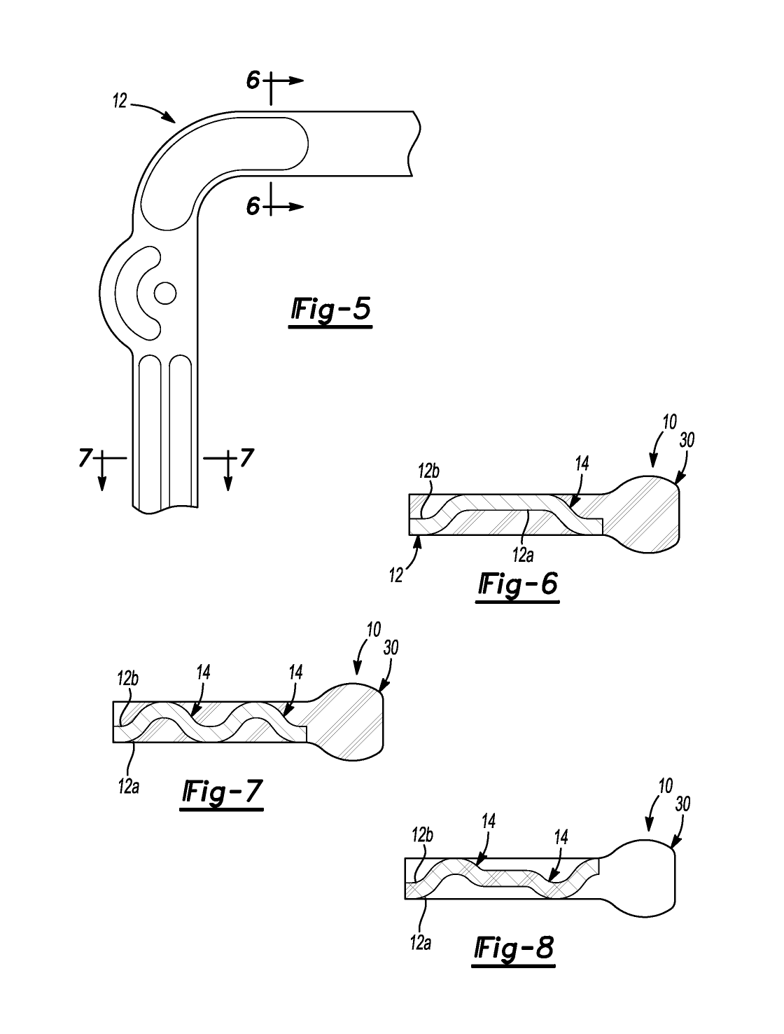

With reference to FIGS. 1-3, a gasket 10 according to the principles of the present disclosure will now be described. The gasket 10 includes a metallic gasket substrate 12 formed of a sheet metal. The substrate 12 can be stamped from a solid sheet and simultaneously formed with a raised bead portion 14 that serves as a load bearing compression limiting feature. The raised bead portions 14, 14′ include a pair of sidewall segments 16, 18 and a top wall segment 20 extending between the sidewall segments 16, 18. Accordingly, the raised bead portions 14 define a concave surface 22 on a first side 12a of the substrate 12 and define a convex surface 24 on a second side 12b of the substrate 12. The raised bead portion 14 of the metallic substrate 12 can be formed as a series of discreet raised bead portions 14 as illustrated in FIG. 1, or alternatively can be formed as a continuous raised bead portion 14′ as illustrated in FIG. 4. Furthermore, as illustrated in FIGS. 5 and 6, the raised bead portions 14 can have a width extending across a majority of the width of the substrate or less than or equal to half of the width as shown in FIG. 2.

In addition, a pair of parallel raised bead portions 14 can be used side by side, as illustrated in FIGS. 5, 7 and 8. As illustrated in FIGS. 7 and 8, the pair of parallel raised beads 14 can extend from the same side 12a (FIG. 7) or from opposite sides 12a, 12b (FIG. 8) of the substrate 12.

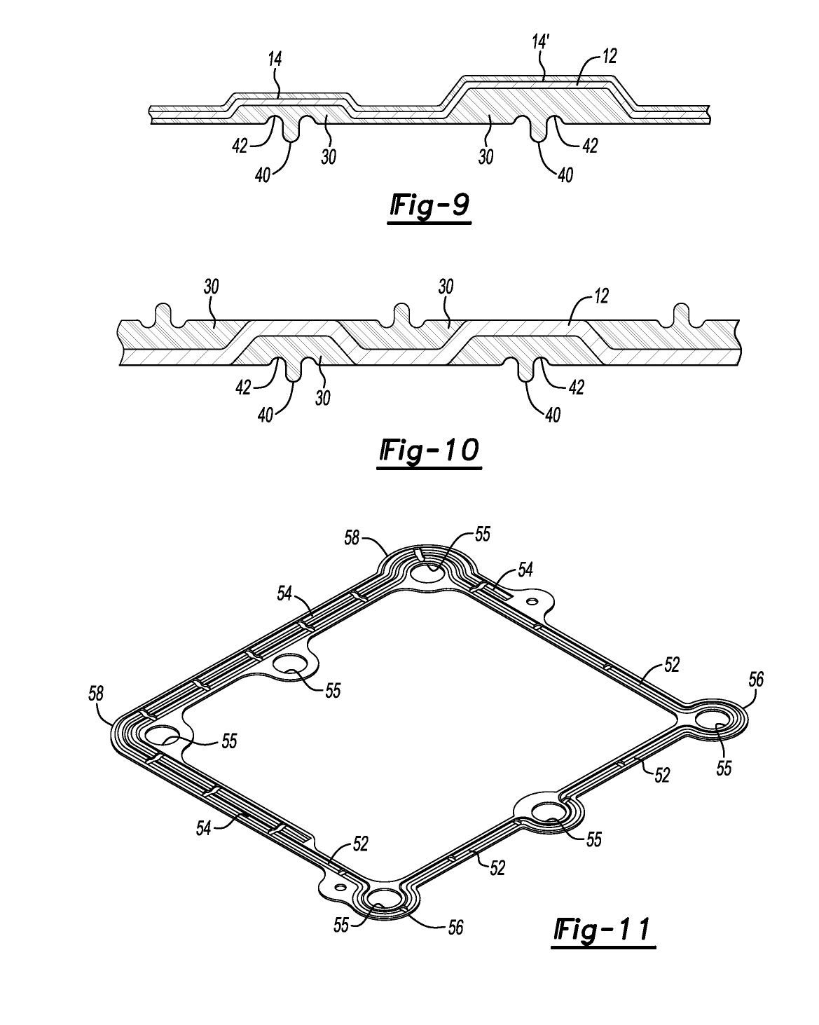

As illustrated in FIG. 9, the raised beads 14, 14′ can be of differing heights and widths in order to accommodate for joint deflection and structural issues with the joint. In particular, the bead 14′ can be taller than the bead 14. The beads 14 and 14′ can be either parallel beads used side by side or they can be formed as a series of discrete raised beads arranged in series having varying heights. In addition, as illustrated in FIG. 9, the gasket substrate can be over-molded with rubber or plastic or other elastomeric material 30 and can be skim coated with a thin layer in the contact regions if needed to provide better sealing. The widths of the raised beads 14, 14′ can also be varied.

The elastomeric material 30 is over-molded on the metallic substrate 12 and defines first and second sealing beads 32, 34 that each extend beyond respective surfaces of the first and second sides 12a, 12b of the substrate 12. It should be understood that the raised sealing beads 32, 34 can include one or more smaller raised beads portions upon the surfaces thereof. Further, the sealing beads defined by the elastomeric material 30 can take many forms and can be located in various locations, either at an edge of the substrate or overlapping the substrate.

The raised bead portions 14 of the metallic substrate provide for a rigid feature in the gasket that creates a load bearing compression limiting feature so that the over-molded elastomeric sealing beads 32, 34 are not overly compressed. This load bearing compression limiting feature has the function of retaining bolt torque while maintaining a constant gap in a bolted joint to control stresses in the gasketing material to enable long service life of the sealing element. The metallic bead shape can be continuous or intermittent as illustrated in the two embodiments shown to enable the proper surface area and structure to support the bolt tightening load to maintain bolt torque. Additionally, the elastomeric material can be utilized in the concave region 22 of the raised bead to add additional support structure to the metallic bead shape to achieve the proper structure. In addition, the gasket material in conjunction with the metallic bead shape is trapped under the metallic bead shape to create a near hydraulic condition to provide the necessary structure to support the tightening load to maintain the torque while providing a limiting feature to control stresses in the gasket material. As illustrated in FIGS. 9 and 10, a void volume type bead 40 can be included in the elastomeric material filling the concave region 22 of the raised bead 14. The void volume bead 40 can be compressed and deformed into the void volume regions 42 adjacent to the bead 40 to enhance the sealing capabilities.

Although the description has been made with respect to a metallic gasket substrate, it should be understood that a plastic gasket substrate could be utilized as illustrated in FIG. 10, where the application allows, based upon load and stress requirements. The plastic substrate can be provided with raised bead(s) which are filled with elastomeric material or plastic as discussed above to serve as compression limiters. Additional raised over-molded elastomeric sealing beads 32, 34, or void volume beads 40 can be provided to provide a seal. The use of plastic as the gasket substrate, where practical, provides a lower cost alternative to the metallic gasket substrate.

With reference to FIG. 11, the gasket substrate 50, whether made from metal or plastic, can have varying widths and/or varying raised bead patterns. In particular, as shown in FIG. 11, the gasket substrate can include narrow regions 52 and relatively wider regions 54 between the bolt holes 55 and can have narrow bolt hole regions 56 and relatively wider bolt hole regions 58. The different regions 52, 54, 56 and 58 can have different raised bead geometries including differing heights and widths as well as parallel, continuous and series arranged raised beads. These variations can be designed into the substrate to accommodate for joint deflection and structural issues with the joint.

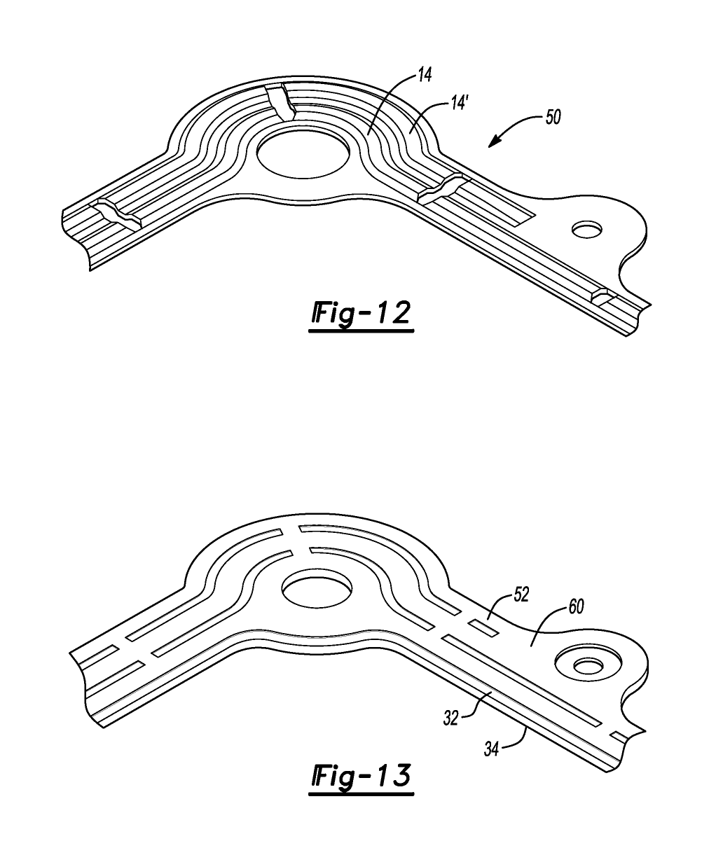

FIG. 12 shows a perspective view of a portion of the gasket substrate 50 of FIG. 11, wherein the raised beads 14, 14′ can be varied in height and/or width to help balance load or create a bending moment to improve sealing or to improve non-sealing component durability (i.e. reducing structural distortion thus reducing friction). The varying heights of the raised beads can include height variations within a single raised bead and/or height variations that occur from bead to bead. FIG. 13 shows a perspective view of a portion of the gasket with the gasket substrate 50 over-molded with an elastomeric material 52 the height of the sealing beads 32, 34 can vary throughout the gasket flange area to accommodate for joint stiffness and load limitations. Further, the height of the elastomeric material can also be varied in the non-sealing bead regions 60 to help improve load distribution.

The features of the present disclosure can be utilized to accommodate for non-flat flanges, aid in reducing flange warpage, allow for greater bolt spans, thinner flanges and provide greater structural rigidity to the joint. The features aid a gasket designer to concentrate the load in areas to help reduce flange warpage and improve sealing and potentially reduce design time.

1. A gasket, comprising:
a gasket substrate defining a generally planar body and having a raised bead portion formed therein, said raised bead portion defining a first generally concave surface on a first side of said substrate and a generally convex surface on a second side of said gasket substrate; and
an elastomeric material over-molded on said gasket substrate and defining first and second sealing beads that each extend beyond respective surfaces of said first side and said second side of said substrate, said over-molded elastomeric material substantially filling said concave surface of said raised bead portion to form a compression limiting feature.

2. The gasket according to claim 1, wherein said raised bead portion includes a continuous bead extending substantially an entire length of said gasket.

3. The gasket according to claim 1, wherein said raised bead portion includes a plurality of discretely formed raised beads spaced from one another along a length of said gasket.

4. The gasket according to claim 1, wherein said raised bead portion includes a pair of side wall segments and a top wall segment extending between said pair of side wall segments.

5. The gasket according to claim 4, wherein said pair of side wall segments are angled relative to said top wall segment.

6. The gasket according to claim 1, wherein said first sealing bead varies in height at different locations around said gasket.

7. The gasket according to claim 1, wherein said raised bead portion includes a pair of parallel raised beads spaced laterally from one another.

8. The gasket according to claim 7, wherein a first one of said pair of parallel raised beads extend from a first surface of said gasket substrate and a second one of said pair of parallel raised beads extend from a second surface, opposite said first surface of said gasket substrate.

9. The gasket according to claim 7, wherein said pair of parallel raised beads extend from a same surface of said gasket substrate.

10. The gasket according to claim 1, wherein said gasket substrate is made from plastic.

11. The gasket according to claim 1, wherein said gasket substrate is made from metal.

12. The gasket according to claim 1, wherein said over-molded elastomeric material substantially filling said concave surface of said raised bead portion defines a void volume-type bead.

13. The gasket according to claim 1, wherein a height of said raised bead portion varies at different locations around said gasket.

14. The gasket according to claim 1, wherein a width of said raised bead portion varies at different locations around said gasket.

15. A gasket, comprising:
a plastic gasket substrate defining a generally planar body and having a raised bead portion formed therein, said raised bead portion defining a first generally concave surface on a first side of said plastic gasket substrate and a generally convex surface on a second side of said gasket substrate; and
an elastomeric material over-molded on said plastic gasket substrate and defining first and second sealing beads that each extend beyond respective surfaces of said first side and said second side of said substrate, said over-molded elastomeric material substantially filling said concave surface of said raised bead portion to form a compression limiting feature.

16. The gasket according to claim 15, wherein said raised bead portion includes a pair of side wall segments and a top wall segment extending between said pair of side wall segments.

17. The gasket according to claim 16, wherein said pair of side wall segments are angled relative to said top wall segment.

18. The gasket according to claim 15, wherein said over-molded elastomeric material substantially filling said concave surface of said raised bead portion defines a void volume-type bead.

19. A gasket, comprising:
a gasket substrate defining a generally planar body and having a raised bead portion formed therein, said raised bead portion defining a first generally concave surface on a first side of said substrate and a generally convex surface on a second side of said gasket substrate, wherein a height of said raised bead portion varies at different locations around said gasket; and
an elastomeric material over-molded on said gasket substrate and defining first and second sealing beads that each extend beyond respective surfaces of said first side and said second side of said substrate, said over-molded elastomeric material substantially filling said concave surface of said raised bead portion to form a compression limiting feature.

20. The gasket according to claim 19, wherein said raised bead portion includes a continuous bead extending substantially an entire length of said gasket.

21. The gasket according to claim 19, wherein said raised bead portion includes a plurality of discretely formed raised beads spaced from one another along a length of said gasket.

22. The gasket according to claim 19, wherein said raised bead portion includes a pair of side wall segments and a top wall segment extending between said pair of side wall segments.

23. The gasket according to claim 19, wherein said over-molded elastomeric material substantially filling said concave surface of said raised bead portion defines a void volume-type bead.

24. The gasket according to claim 19, wherein a width of said raised bead portion varies at different locations around said gasket.

25. A gasket, comprising:
a gasket substrate defining a generally planar body and having a raised bead portion formed therein, said raised bead portion defining a first generally concave surface on a first side of said substrate and a generally convex surface on a second side of said gasket substrate; and
an elastomeric material over-molded on said gasket substrate and defining first and second sealing beads that each extend beyond respective surfaces of said first side and said second side of said substrate, said over-molded elastomeric material substantially filling said concave surface of said raised bead portion to form a compression limiting feature, wherein said over-molded elastomeric material substantially filling said concave surface of said raised bead portion defines a void volume-type bead.
